(19) United States
(12) Patent Application Publication
(10) Pub. No.: US 2007/0185608 A1
(43) Pub. Date: Aug. 9, 2007

(54) Portable hand-held CNC machine tool programming device

(76) Inventor: Richard Raymond Ragnini, Plainfield, IL (US)

Correspondence Address: RBR ASSOCIATES INC., 8408 WILMETTE AVE., DARIEN, IL, 60561, US

(21) Appl. No.: 11/725,233

(22) Filed: Mar. 19, 2007

Related U.S. Application Data
(63) Continuation of application No. 10/410,356, filed on Apr. 10, 2003.
(60) Provisional application No. 60/371,681, filed on Apr. 12, 2002.

(51) Int. Cl. G06F 19/00

(52) U.S. Cl. 700/180; 700/87

(57) ABSTRACT

A wireless handheld device such as a Palm computer configured to download G-code instructions to a Computerized Numerical Control (CNC) machine is disclosed. The G-code instructions can be edited and loaded onto the handheld device from a stationary PC. The handheld device communicates with the CNC machine using a specialized serial cable.

### CROSS-REFERENCE TO RELATED APPLICATIONS

This application claims priority to U.S. application Ser. No. 10/410,356, filed on Apr. 10, 2003, which in turn claims priority to U.S. Provisional Application No. 60/371,681, filed on Apr. 12, 2002.

### FIELD OF THE INVENTION

This invention relates generally to a wireless handheld device, such as a Palm (™), configured to download G-code instructions to a Computerized Numerical Control (CNC) machine. The software loaded on the handheld device can be edited or reconfigured directly on the handheld device, or from a PC and then transferred to the handheld device.

### BACKGROUND OF THE INVENTION

It is customary within the machine tool industry for CNC machines to take operating instructions using a means of communication known as G-code, which was originally communicated through hole-punched paper tape. For example, G0X1Z3 is a G-code command to make a CNC machine move a part using a 3D coordinate system having X, Y, and Z axes. G is the most important of the G-code letters, and is used to indicate movement or positions. G0 means move at the speed of the machine, where X and Z are positions and points. Thus, a CNC machine moves the part 1 inch on the X axis, 3 inches on the Z axis, at one times the predetermined rate of speed. The distances could be in millimeters, or in polar coordinates instead of rectangular. The letters M and S also have significance in G-code programs. M stands for Miscellaneous instruction. S stands for the Speed at which a CNC operation, such as cutting of a part, occurs.

It is now widely-accepted for CNC machines to have built-in RS-232 serial ports. However, storing and managing the G-code within the CNC machine has presented significant challenges at least partly because of the harsh industrial environment typically associated with CNC machines, including but not limited to dirt, dust, electrical noise, vibration, and fluctuations in temperature. Also, even modern CNC machines contain very limited amounts of RAM. Because CNC machines can last as long as 25-30 years, many legacy CNC machines which have their G-code instructions communicated via paper-tape devices or other rudimentary low-speed serial devices are still in production and are still profitable to operate. Consequently, a portable computing device which can quickly and consistently download G-code to CNC machines while emulating such low-speed communication devices in a harsh manufacturing environment is desired.

### BRIEF SUMMARY OF THE INVENTION

This invention has as its primary objective the downloading of G-code programs from a portable computing device such as a Palm (™) device to CNC machines through a legacy low-speed communication port in a harsh manufacturing environment. Using the present invention, users can define up to 1000 unique CNC machine profiles, and can store up to 1000 unique G-code programs within each machine profile. The profiles and G-code programs can be easily and safely stored using readily available one-touch synchronization software.

A further objective of the present invention is to load a copy-protected software module on the Palm device for managing user preferences, storing and editing G-code sequences, and communicating with the serial port of the CNC machine. Yet another objective is to provide a specialized cable which communicates between the serial port of the Palm device and the serial port of the CNC machine.

These and other objects and advantages of the invention will become readily apparent as the following description is read in conjunction with the accompanying drawings.

### BRIEF DESCRIPTION OF THE DRAWINGS

FIG. 1 is a plan view of the handheld device and stationary PC of the present invention, in communication with a CNC machine;

FIG. 2 shows an icon representing the software module of the present invention as displayed on the handheld device of FIG. 1;

FIG. 3 shows some of the software menus contained within the software module of FIG. 1;

FIG. 4 shows an exemplary file selection available when a user taps on the load button of FIG. 2;

FIG. 5 shows further details of the cable of FIG. 1;

FIG. 6 shows the software module of the present invention displaying O-numbers;

FIG. 7 shows the O-numbers of FIG. 6 appended with additional characters;

FIG. 8 shows a Memo pad application on handheld device;

FIG. 9 shows a specific memo selected from the list shown in FIG. 8;

FIG. 10 shows a directory listing showing the first 25 characters of each entry of FIG. 8;

FIG. 11 shows a single handheld device of the present invention controlling multiple CNC machines;

FIG. 12 shows the communication menus of the present invention;

FIG. 13 shows how to select the IR communication option of the present invention;

FIG. 14 shows the IR implementation of the present invention; and

FIG. 15 shows multiple handheld devices of the present invention communicating with multiple CNC machines.

### DETAILED DESCRIPTION OF THE PREFERRED EMBODIMENTS

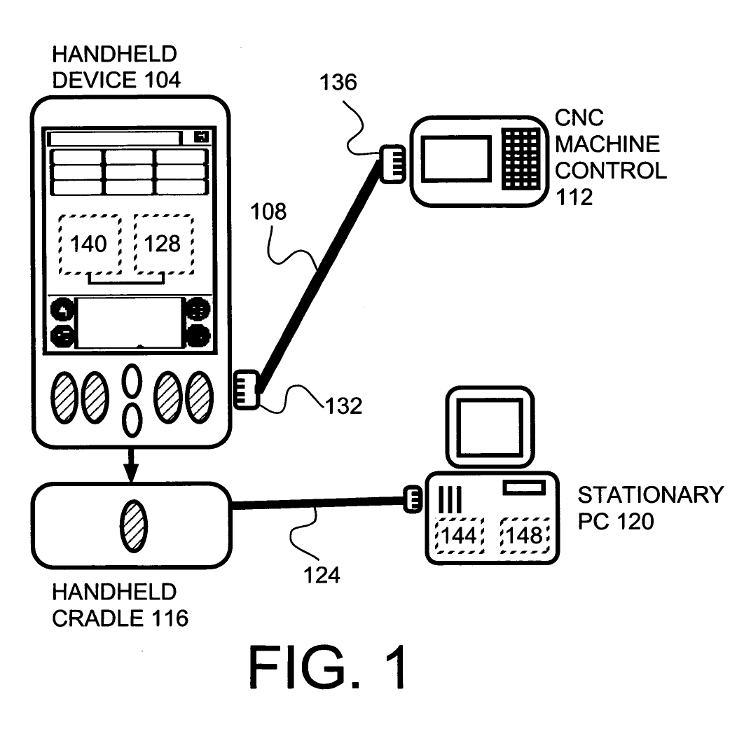

FIG. 1 shows an exemplary representation of the present invention. In FIG. 1, a battery operated portable handheld computing device 104 such as but not limited to a Palm (™) device is shown connected to a CNC machine 112 via a specialized cable 108. The handheld computing device 104 sits in a cradle 116 which allows high speed backup and restoration (synchronization) of the computing device 104 with a stationary computer 120 such as a standard PC, which can be located away from the harsh CNC environment. One example of such a synchronization utility is HotSync (™), although the present invention should not be considered as limited exclusively thereto. A specialized software module 128 is located on the handheld device 104, and manages the memory storage area 140.

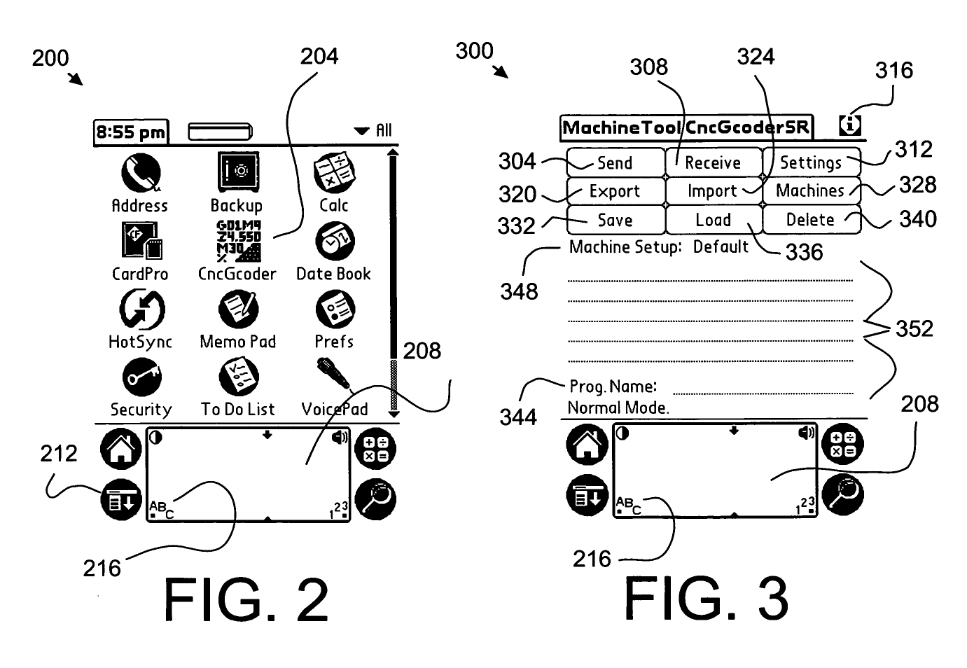

At the time of drafting of this application, many CNC machines contain an RS-232 serial port. However, unlike the rest of the computer industry, serial ports are still relatively new to the CNC industry. Only recently have CNC machines 112 been equipped with a self-contained serial port. As stated, the Input/Output (I/O) mechanism for sending instructions to be executed by many legacy CNC machines 112 is still punched paper tape. Thus, the present invention emulates the punch paper tape function with the handheld device 104, but the CNC machine 112 still thinks it's talking to a paper tape meter or a paper tape punch. Accordingly, FIG. 2 shows an exemplary menu interface 200 available when a user initializes the handheld device 104 of the present invention. Icon 204 is intended to resemble a small G-code program. The dotted portion in the lower RH portion of the icon 204 is intended to resemble punched paper tape. The present invention employs such iconography because it is familiar to a typical CNC machinist.

The user operates the handheld device 104 by tapping on the icons in FIG. 2 with a stylus (not shown), although a mouse or touchpad implementation is also contemplated within the present invention. To activate pull-down menus, a user clicks on the pull-down menu button 212. A user can input hand-written commands into the free-form user edit area 208 which can recognize handwriting but also includes a keyboard if the user taps on the ‘ABC’ icon 216.

The user interface of the present invention takes into account the overall strategy that activities performed most often should be designed to require the least amount of user taps or stylus movements. Activities that users do a lot are implemented with one tap. The activities users do sometimes, implement maybe with a couple of taps. The activities users do very little, implement with 3 or 4 taps, Looking at FIG. 3, a tutorial on how to operate the software module 128 is available under the symbol ‘i’ (316) which stands for information. This symbol ‘i’ is widely used within handheld devices to comply w/visual interface guidelines. Handheld devices used with the present invention can be running either Palm O/S, Windows CE for embedded devices, Windows CE for Palm Devices (also know as Pocket PC or PPC), or Linux for handhelds.

If the user taps on the icon 204, a menu such as that shown in FIG. 3 is displayed. FIG. 3 shows the main menu 300 of the software module 128 of the present invention. The main menu 300 displays, among other things, nine user buttons including Send 304, Receive 308, Settings 312, Export 320, Import 324, Machines 328, Save 332, Load 336, and Delete 340. The lined edit area 352 in the middle of the screen 300 contains the current CNC program information and is fully editable using either the free-form user edit area 208 or the keyboard from ‘ABC’ icon 216.

In FIG. 3, the Program Name area 344 displays the current CNC program name and is editable. The Machine Setup 348 area displays the currently active CNC machine's settings. The buttons shown in FIG. 3 work as follows:

SEND Button 304: Tapping the Send button 304 transmits a CNC program to the CNC machine 112. During such a transmission, a user can tap the screen anywhere to abort the send.

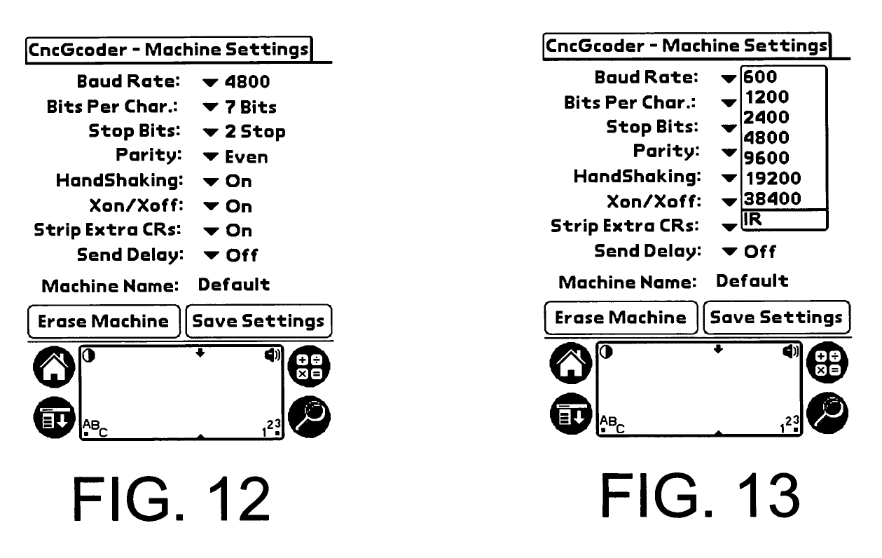

RECEIVE Button 308: Tapping the Receive button 308 places the handheld device 104 into “receive” mode. Like with the Send button 304, a user can tap the screen anywhere to abort a transmission from the stationary PC 120. The receive module of the software module 128 program will time-out after 30 seconds if no data is received. However, one problem exists between the handheld device 104 and the stationary PC 120. ASCII, the typical text format used in most PCs, uses both Carriage Return (CR) and Line Feed (LF) characters to symbolize the end of a line of text. CNC machines, however, only use the LF portion and not the CR. Certain Operating Systems (O/S) also only use the LF portion. Thus, transmitting data from the stationary PC 120 to the handheld device 104 can require stripping of all CR portions. As shown in FIG. 12, a proprietary receiving routine includes a Strip Extra CR's setting which allows the software module 128 to remove any extra CR's not expected by a specific CNC machine 112 when receiving a G-code program. Also as shown in FIG. 12, the Strip Extra CR's feature can be disabled because some CNC machines actually expect multiple CR's.

As stated, it is necessary to load G-code sequences into the handheld device 104 prior to driving a CNC machine 112. During such a sending process, the O/S loaded onto the handheld device 104 uses a “null” character ‘Ø’ as an end-of-string terminator. Unfortunately, this “null” character ‘Ø’ is often used within G-code sequences to create ‘leader’ space on the paper tape. Accordingly, the software module associated with the Receive button 308 incorporates a proprietary receiving routine which strips out all “null” characters ‘Ø’ instead of the generic receiving routine typically packaged with most handheld devices 104.

After tapping the Receive button 308, the software module 128 posts a message stating “ready to receive data”. If the handheld device 104 does not receive data from the stationary PC 120 for 5 seconds, the handheld device 104 will time out.

SAVE Button 332: Tapping the Save button 332 will save the currently displayed CNC Program in a Memo application that is typically packaged with handheld devices. This save option allows G-code programs to be exported to the stationary PC 120 at synchronization time for saving or editing as PC files. The software module 128 must be given a name on the Prog. Name: line (344) before the CNC program can be saved. The saved program is linked to the currently active Machine Setup, but the same program or program name can be saved under multiple machine setups. Due to a file size limitation of the Memo application, only G-code programs 4,000 characters or less can be saved using the Memo application.

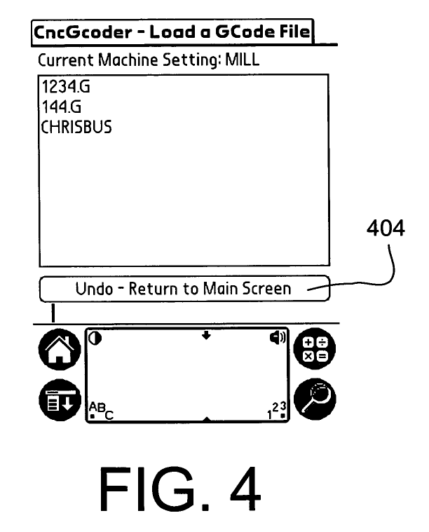

LOAD Button 336: Tapping the Load button 336 will display all G-code Memos in the memory storage area 140 saved under the currently active Machine Setup. A single CNC machine can have numerous G-code programs associated therewith. As shown in FIG. 4, a user can then tap on a specific program file such as 1234.G, 144.G, or CHRISBUS to retrieve that program for editing or sending to a CNC machine 112. In the event the user does not wish to load a different program file, the user can tap the “Undo” button 404 to exit the screen without any changes. If a user does not wish to load a Memo Pad file, they can tap an “Undo” button (not shown) to exit the screen without any changes.

DELETE Button 340: Tapping the Delete button 340 will remove the current program under the current machine settings from the memory storage area 140 only. For convenience and to protect the user from inadvertent erasing, the program and program name will stay in the “edit” area 352 (FIG. 4) and can still be saved or edited.

IMPORT Button 324: Tapping the Import button 324 will load in to the edit area 352 a specially formatted file from the stationary PC 120. The imported file is created from a standard PC file using a proprietary TOPALM conversion software module 144 stored on the stationary PC 120. Within handheld devices that use the Palm Operating System (O/S), compiled executable applications are labeled .prc, as opposed to .exe or dat. The P stands for Palm and the RC for ResouCe. Handheld devices such as Palms are not like typical PCs. They do not have a hierarchical file system, and do not store data in individual files. Instead, information is stored as “records” in a table or database known as a .pdb (Palm DataBase) file. Accordingly, a typical PC application still cannot open or access these records within a database. The data in the handheld device 104 gets backed up and archived in the stationary PC 120, but is not in an editable form on the PC. Instead, the data is buried in an archived format unique to the handheld O/S. The data may be stored in a directory that the synchronization software designates, but the user cannot access it. Many customers appreciate the idea of taking this program out of the machine, walking in the office with the handheld device, sticking the handheld device in its cradle 116 connected to the stationary PC 120 and then being able to edit G code files in a non-CNC shop floor, air-conditioned office environment. To accommodate such users, the FROMPALM conversion software 148 (FIG. 1) enables standard PC editors to view and edit the separate records within a .pdb (palm database) file, and the TOPALM conversion software 144 (FIG. 1) allows the edited files to be reconverted to the standard handheld format prior to sending to the handheld device 104.

EXPORT Button 320: Tapping the Export button 320 will save the currently displayed CNC Program in a specially formatted file that is saved on the stationary PC 120 at synchronization time. This file can later be converted to a standard PC file using the proprietary FROMPALM software conversion module 148 (FIG. 1) also stored on the stationary PC 120. Only the most recently exported file is sent to the stationary PC 120 at synchronization time.

A potential incompatibility between the handheld device 104 and the stationary PC could exist. This incompatibility arises from the difference between Motorola (Palm) and Intel (PC) microprocessors, which have opposite bigEndian and littleEndian data storage conventions. The TOPALM and FROMPALM modules 144, 148 manage and convert these formats where necessary, allowing the transmission of live data back and forth yet preserving accessibility from either position.

Another problem is that the Palm “memo” program can only handle 4000 characters/file, while the present invention can handle memos or sequences up to 1,000,000 characters long. The TO-PALM and FROM-PALM modules 144, 148 overcome this limitation.

MACHINES Button 328: Tapping the Machines button 328 will display all CNC machine setups in the memory storage area 140. A user can tap on the Machine Setup area 348 to make it active. For safety the current program and program name will stay in the edit area 352, but activating a different setup will affect the communications settings immediately.

SETTINGS Button 312: Tapping the Settings button 312 will display the current communication settings which can be changed to match a specific CNC machine's configuration by tapping on specific items, as shown in FIG. 12. The CNC machine 112 must be setup to communicate using ISO or ASCII paper punch codes. As shown in FIG. 12, the Machine Name is the name of a specific CNC machine's communication settings profile and can be changed and saved under a different name to create a new CNC machine communication settings profile. A user can tap the Save Settings button to update the machine settings profile and exit the setup page. The Erase Machine button is used to permanently remove the current machine settings profile and all G-code Programs associated with those machine settings profile.

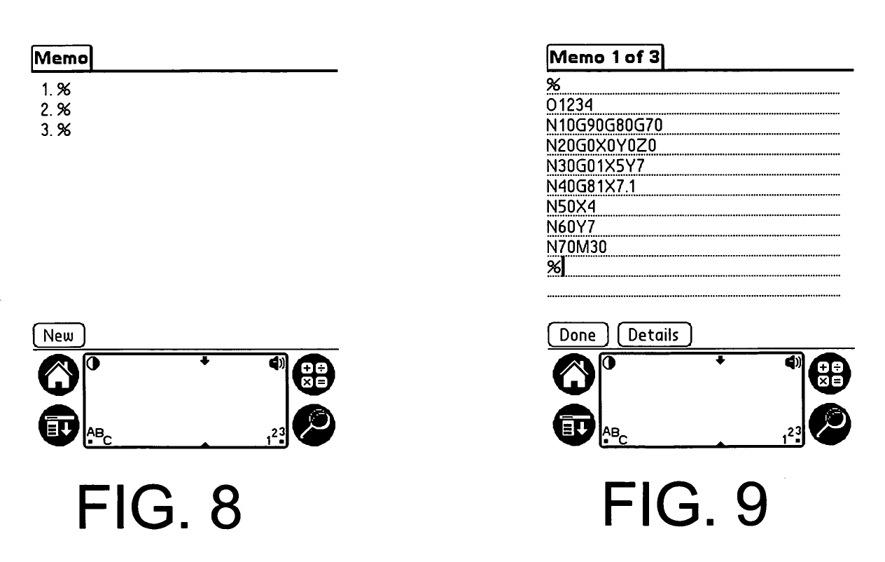

As shown in FIG. 8, the handheld device 104 contains a “Memo Pad” feature. Tapping the Memo Pad feature allows access to “Save Memo” and “Get Memo” buttons, which are used to import and export PC files to the portable device 104. Specifically, tapping the “Save Memo” button will save the currently displayed CNC Program in the Palm Memo Pad program. This save option allows G-code programs to be exported to the desktop PC at synchronization time for saving or editing as PC files. Tapping the “load” button will display all Memo Pad files in the handheld device. After tapping the “load” button, a user can tap on the file to import it into the software module 128 for editing or sending.

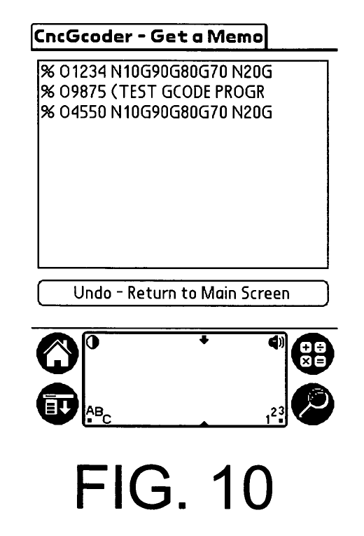

The Memo program that typically comes with handheld devices takes the first line of the separate .pdb files and uses those first lines as identifiers or filenames. Most memos containing a G-code program contain a ‘%’ sign in their first line. Three such memo files are shown in FIG. 8. However, a mere 3 ‘%’ signs without any other information makes it almost impossible to separate or identify a specific file or G-code file. A directory listing of all memos is shown in FIG. 9. The code of the Memo program that typically comes with handheld devices takes the first line of the memo and uses those first lines as identifiers or filenames. Most G-code programs contain only the ‘%’ (percent sign) as their first line, as shown in FIG. 8. A listing holding a mere 3 ‘%’ signs, without any other information, makes it almost impossible to separate or identify a file. The software module 128, however, overcomes this problem using the “import memo” feature. As shown in FIG. 10, the directory listing of the “import memo” feature shows the first 25 characters of the memo, regardless of line breaks. Such a feature makes it much easier to identify specific memos, as can be discussed by contrasting FIG. 8 with FIG. 10.

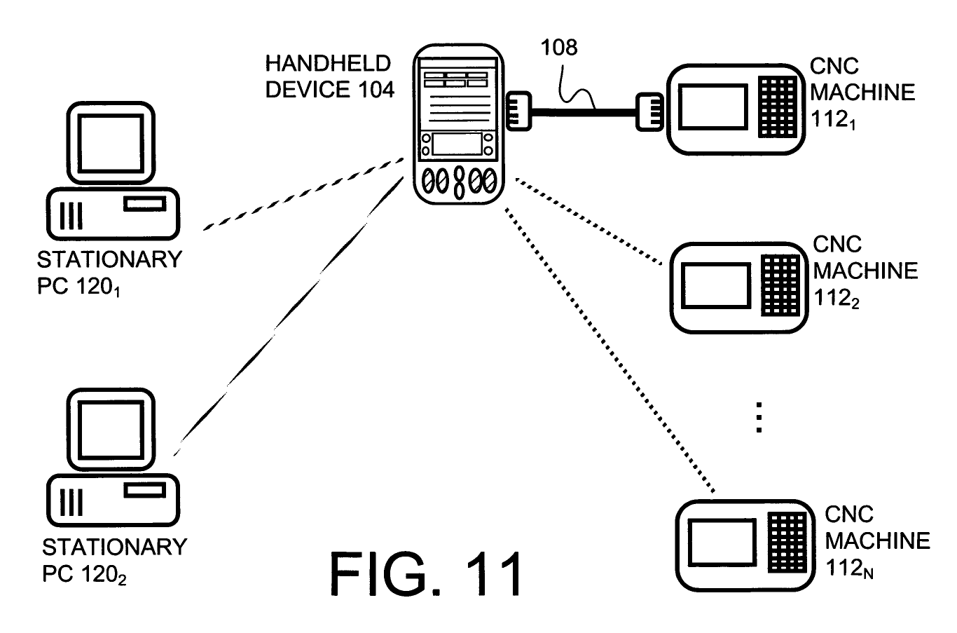

A user can transfer the data from one handheld device 104 to another by infrared or by a cable, and can also put a modem on the handheld device 104 and do a communication to a remote system via a PC. Thus, one doesn't necessarily need a cable 108 to synchronize with a stationary PC 120. G-code programs and CNC machine profiles can also be communicated from handheld to handheld wirelessly. Also, a single handheld device 104 can be connected to multiple stationary PCs 120 and multiple CNC machines 112, as shown in FIG. 11. Indeed, a single handheld device of the present invention can operate a wide variety of CNC machines, each of which can have differing requirements, speeds, tolerances, and thresholds.

If the batteries for the handheld device 104 are lost, if the handheld device 104 is dropped, broken, or replaced, the data on the handheld device 104 can be restored by synchronization with the stationary PC 120. Synchronization is as simple as dropping a handheld device 104 into the cradle 116 and initiating the synchronization software, either from the handheld device 104 or the stationary PC 120. The data within the handheld device 104 is then completely restored including all settings, parameters, and data.

The users of the present invention can use Macintosh computers, even though Macs have no serial port. The present invention could be adapted to Mac by connecting the Mac's Universal Serial Bus (USB) to the serial port 132 of the handheld device 104.

If the serial port of the handheld device 104 doesn't get any data it'll time out in 30 seconds and post a message apprising the user of this fact. The 30 seconds is based on power-saving considerations. Most users will know in 30 seconds whether the handheld device 104 is connected properly or not. A longer delay would needlessly drain the batteries within the handheld device 104.

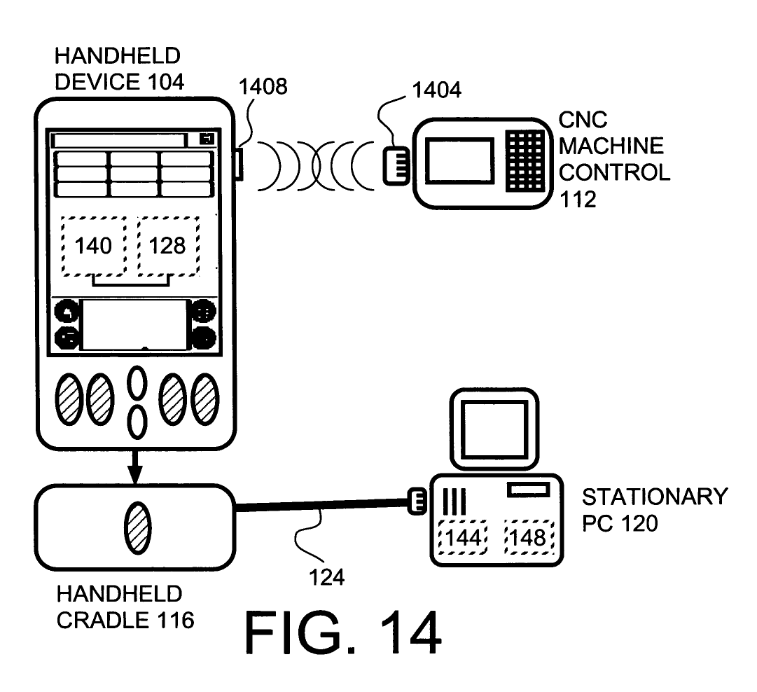

As shown in FIG. 1, the specialized cable 108 is a required portion of the present invention (except in the InfraRed (IR) embodiment of FIG. 14). The connector 132 links with the bottom of the handheld device 104, as shown in FIG. 1. The other end of the cable 108 has a 25 pin D-shell connector 136 which connects to a serial port of the CNC machine 112. Connecting the cable 108 is not sufficient by itself to ensure 3proper communication between the handheld device 104 and the CNC machine 112. A user must also ensure that the communication settings (FIG. 12) are properly matched up with the settings of the specific CNC machine 112 to which it is connected.

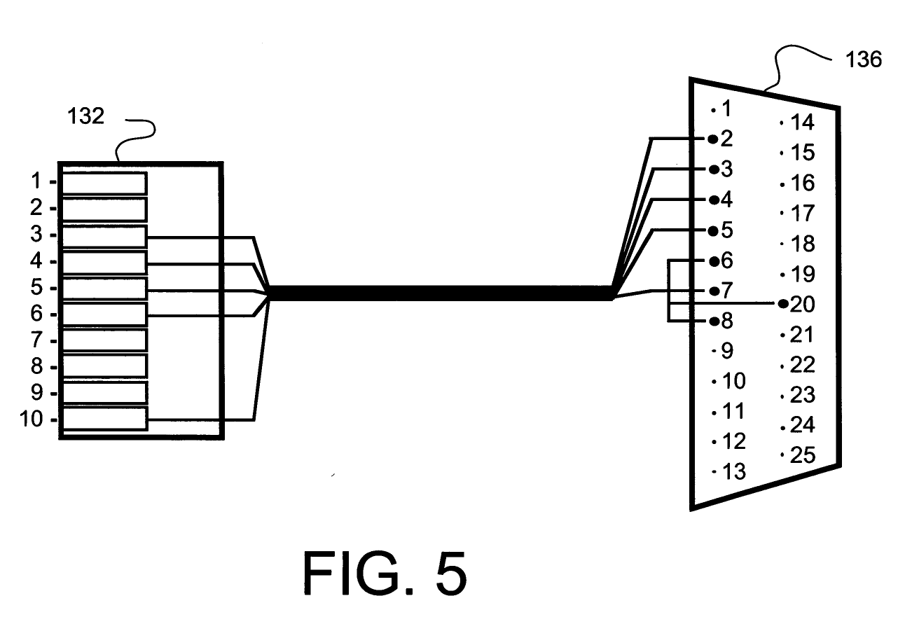

FIG. 5 shows additional detail of the 25 pin D-shell connector 136 and the 10-pin edge connection 132. Not every pin is populated in the 25-pin connector 136. This is because many CNC machines put live voltages on unused pins in order to supply power to peripherals or to accomplish some other purpose. Thus, attaching an unmodified serial cable to a CNC machine could result in damage to the handheld device 104 or injury to the user. To avoid these and other problems, several pins in the 25-pin connector 136 are not populated. The specialized cable 108 has the standard transmit, receive, and ground pins, but also supports hardware handshaking with the Request to Send (RTS) and Clear to Send (CTS) functions (see FIG. 12).

The cable 108 also shorts together pins 6, 8, and 20, which tells the CNC machine 112 that a cable is connected. Some CNC machines will refuse to operate unless pins 6, 8, and 20 are connected, because otherwise the CNC machine would not be aware that any cable or paper tape device is connected thereto.

The cable 108 requires no specialized tools and can be attached and detached using thumbscrews, because it may be attached and detached from several different CNC machines in the same day. The cable 108 can vary in length from 3 to 25 feet, depending on the baud rate of the CNC machine the cable 108 is attached to. Typical CNC machines operate between 1200 and 9600 baud.

Another problem solved by the present invention is that CNC machines typically have a female 25-pin serial port, while most laptop computers have coalesced around a 9-pin male serial port Thus, anyone trying to duplicate the features of the present invention using a laptop computer will have to overcome the CR/LF problem, the “null” (Ø) problem, and also the 9-pin v. 25-pin problem. This problem is aggravated by the fact that a 9-pin interface has no way to short together pins 6, 8, and 20 as is expected by many CNC machines. Thus, the present invention is better suited to a typical CNC shop floor environment than a laptop computer, although a further embodiment of the present invention exists in which the screen displays, communication, and file management are implemented within a typical laptop.

Another feature of the present invention is an “autosave” feature. The software module 128 automatically saves the buffer whenever anything else happens in the handheld device 104. Whether it goes to sleep, it's turned off or it switches to a different app, the software module 128 automatically saves all data from all applications without any user intervention. Most handheld applications auto-save data related to their own application, but do not accomplish such saving for all applications currently active in the handheld memory buffer 140. The software module 128 retains data even when shut off, and protects the user from accidentally erasing data including from applications unrelated to G-code management.

A user may attempt to delete a specific G-code program or memo by highlighting it and then touching “erase” or “delete”. A dialog window would then open which says “Do you want to delete file”? When a user hits “yes”, the G-code program or file appears to have been deleted. However, the above steps only deleted the file from the directory of programs, but not from the screen area. The G-code program or file can be deleted from the directory of a specific CNC machine profile, but later saved under the profile of another CNC machine. This is because the software module 128 ensures that nothing in the memory area buffer 140 of the handheld device 104 gets erased until the user over-writes the data with new data.

After a user has gone to the trouble of installing a G-code program to be run, the present invention reduces the risk of accidentally erasing or over-writing that G-code program. To not change the settings, a user could avoid changing a memo-name, then hit the “Save” button. Another way is to hit the “Home” button. A user can then shut off the handheld device 104. Upon turning it back on, all memory is stored the same way it was prior to shut-off. The handheld buttons are typically very small, while the user's fingers may be large and or dirty, or the user is not familiar with operating the stylus of the handheld device 104. Thus, on a shop floor, it is easy to hit one wrong button and lose something. The above feature makes it easier to recover from such a hitting of a wrong button.

G-code programs are usually not large, thus most CNC controllers do not have much memory. Also, a typical G-code program occupies approximately 2Kbytes of RAM. Thus, the 8MB memory capacity of the present invention is more than sufficient to meet the needs of CNC machines as they exist today and in the foreseeable future.

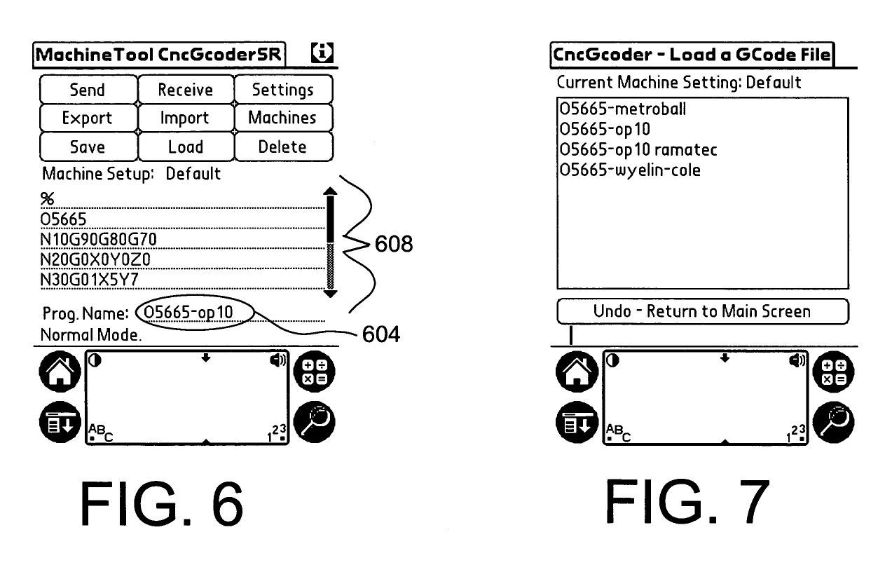

Some CNC machines can store multiple G-code files, but only in a crude, rudimentary format in which the files are listed by 4-digit numbers preceded by an ‘O’, which functions as a type of filename. This is known as an “O-number”, an example of which is shown in the editing area 608 of FIG. 6. Such a requirement makes it difficult to get a recognizable English description from a directory listing of all available filenames, which could increase user difficulty in locating/identifying G-code files. To overcome this problem, the present invention allows appending of additional characters after (or before) the O-number. As shown in FIG. 7, O5665 is a typical O-number. However, the O-number O5665 is followed by ‘op10’ (which in G-code symbolizes a first operation) and then followed by other information that helps understand specific separate CNC machine configurations. As shown in FIG. 7, these include “ramatec”, “wyelin-cole”, or “metroball”, which can be names of specific parts or customers. Thus, users can develop their own naming schemes to help organize and sequence G-code files on the handheld device 104. None of these names get transmitted to the CNC machines 112. The only names that get transmitted to the CNC machines are those shown in the editing area 608 of FIG. 6, which shows the G-code program itself as designated by the “Prog. Name:” field (604).

All Palm devices are manufactured with a unique serial number. During the loading and assembly process of the present invention, the software module 128 is separately compiled to contain each separate unique serial number. At run-time (not compile-time), the software module 128 calls to the handheld O/S to obtain the unique serial number, and compares that with the serial number hard-coded within each separate copy of the software module 128. Thus, each version of the proprietary software module 128 is unique, so that copies are not transferable between separate handheld devices 104. Also during the loading and assembly process, the customer's name can be burned into a flash memory area (ROM) of each handheld device 104 prior to distribution. Doing so is useful for security and for preventing unauthorized copying.

The software module 128 can be stored either in RAM area 140 or ROM of the handheld device, and works directly with the handheld O/S. To draw items on the handheld display, to display a dialog box, to get a tap on the screen or other type of user input, to invoke the keyboard, to access the memory area 140, it is necessary to request resources through the handheld O/S. Such requests are made by accessing the O/S Application Program Interfaces (APIs). The software module 128, however, goes around the handheld O/S to manage the serial port of the handheld device 104. This is because the handheld O/S APIs for managing the serial port are not adequate for the reasons described earlier (CR/LF, ‘null’, etc). Instead, the software module 128 writes directly to the serial port.

As shown in FIG. 14, an InfraRed (IR) embodiment is also contemplated within the scope of the present invention. In the IR embodiment, the cable 108 is replaced by an IR receiver 1404 attached to the CNC machine 112. Some handheld devices 104 come equipped with IR transmitter/receivers 1408. The IR communication option is shown in FIG. 13.

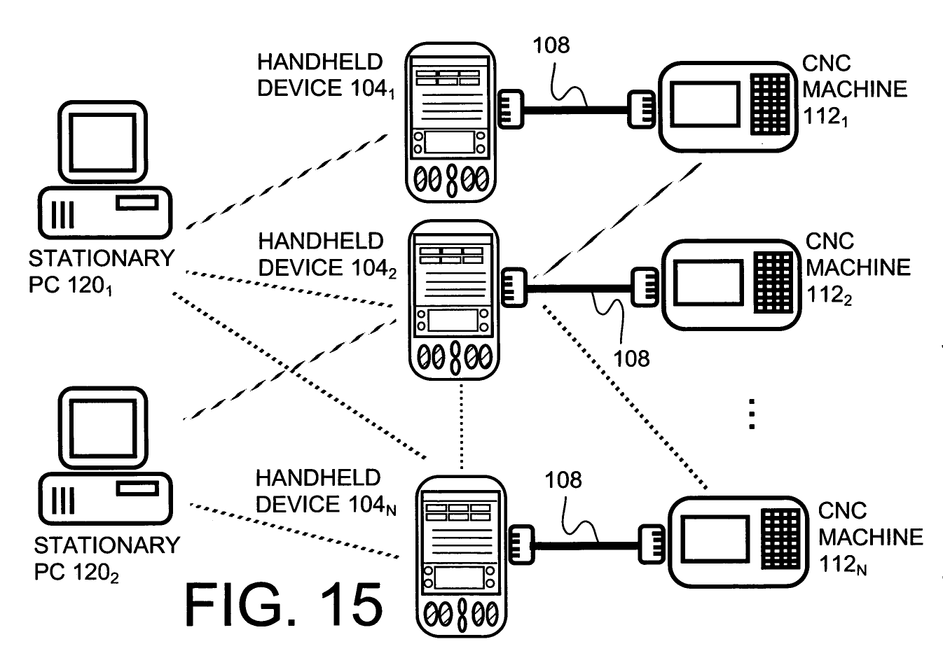

As shown in FIG. 15, a multi-handheld multi-CNC embodiment is also is also contemplated within the scope of the present invention. Sometimes, several CNC machines 112_{1-N} must all be initialized at exactly the same time. In such a case, several handheld devices 104_{1-N} can be simultaneously employed. These handheld devices communicate not only with each other but also with any of the CNC machines 112_{1-N}. Furthermore, the handheld devices 104 can communicate with a plurality of stationary PCs 120.

It is anticipated that various changes may be made in the arrangement and operation of the system of the present invention without departing from the spirit and scope of the invention, as defined by the following claims.

What is claimed is:

35. A controller for communicating instructions to a CNC machine, comprising:
a wireless handheld device;
a software module loaded on the handheld device, wherein the software module further comprises a menued visual interface for allowing a user to edit and move data between the handheld device and the CNC machine; and
a specialized cable for connecting the handheld device to the CNC machine.

36. The controller of claim 35, wherein the instructions are loaded to the handheld device from a stationary PC.

37. The controller of claim 35, wherein the menued visual interface further comprises a send button for activating a send routine within the software module which

38. The controller of claim 35, wherein the menued visual interface further comprises a receive button for activating a receive routine within the software module which allows the user to select stripping of all Carriage Returns.

39. The controller of claim 35, wherein the menued visual interface further comprises a receive button for activating a receive routine within the software module which strips all null characters.

40. The controller of claim 35, wherein the menued visual interface further comprises a settings button for activating a settings routine within the software module which displays and allows editing of communications settings of the handheld device to match those of a specific CNC machine.

41. The controller of claim 36, wherein the menued visual interface further comprises an export button for activating an export routine within the software module which saves the currently displayed CNC Program in a specially formatted file that is saved on the stationary PC at a synchronization time, wherein the file can later be converted to a standard PC file using a FROMPALM software conversion module stored on the stationary PC.

42. The controller of claim 41, wherein the FROMPALM software conversion module manage and convert bigEndian and littleEndian formats thereby allowing the transmission of live between the handheld device and the stationary PC.

43. The controller of claim 35, wherein the software module can accommodate memos or sequences up to 1,000,000 characters long

44. The controller of claim 36, wherein the menued visual interface further comprises an import button for activating an import routine within the software module which loads in to an edit area a specially formatted file from the stationary PC, wherein the imported file is created from a standard PC file using a TOPALM conversion software module stored on the stationary PC.

45. The controller of claim 35, wherein the menued visual interface further comprises a machines button for activating a machines routine within the software module which displays all CNC machine setups in the memory storage area of the handheld device, wherein a user can tap on the Machine Setup area to make it active and editable.

46. The controller of claim 35, wherein the menued visual interface further comprises a save button for activating a save routine within the software module which saves the currently displayed CNC Program in a Memo application packaged with handheld devices.

47. The controller of claim 46, wherein the menued visual interface further comprises a load button for activating a load routine within the software module which displays all CNC instruction programs in a memory storage area saved under the currently active Machine Setup, wherein a user can then tap on a specific program file to retrieve that program for editing or sending to a CNC machine.

48. The controller of claim 46, wherein the menued visual interface further comprises a delete button for activating a delete routine within the software module which removes the current program under the current machine settings from the memory storage area.

49. The controller of claim 35, wherein the menued visual interface shows the first 25 characters of a memo regardless of line breaks.

50. The controller of claim 35, wherein the software module times out a serial port of the handheld device menued after 30 seconds.

51. The controller of claim 35, wherein the cable has several pins unpopulated.

52. The controller of claim 35, wherein the cable has pins 6, 8, and 20 hard-wired together.

53. The controller of claim 35, wherein the software module auto-saves all data belonging to all applications loaded into a memory area of the handheld device.

54. The controller of claim 35, wherein the menued visual interface enables appending additional characters to an O-number corresponding to a specific set of CNC instructions.

55. The controller of claim 35, wherein the software module further comprises:
a unique serial number associated with each separate handheld device compiled therein;
a routine for requesting the unique serial number from the handheld device compiled therein, so that the two serial numbers can be compared for copy-protection purposes.

56. The controller of claim 35, wherein the handheld device runs a version of Palm operating system.

57. The controller of claim 35, wherein the handheld device is a laptop running a version of Windows operating system.

58. The controller of claim 35, wherein the handheld device runs a version of Windows CE for Palm (Pocket PC) operating system.

59. The controller of claim 35, wherein the handheld device runs a version of Linux operating system.

60. The controller of claim 56, wherein the software module makes requests of the operating system for accessing most portions of the handheld device, excepting that the software module writes directly to a serial port of the handheld device without requesting access to the serial port from the operating system.

61. The controller of claim 35, wherein the handheld device communicates with a plurality of CNC machines.

62. The controller of claim 35, wherein a plurality of handheld devices communicate with a plurality of CNC machines.

63. The controller of claim 63, wherein the plurality of handheld devices communicate both with the plurality of CNC machines as well as with each other.

64. The controller of claim 35, wherein the handheld device further comprises a wireless infrared transmitter and the cable is replaced by a wireless receiver attached to the CNC machine.

65. The controller of claim 35, wherein the instructions are G-code instructions.
